(19) United States
(12) Patent Application Publication
(10) Pub. No.: US 2026/0259138 A1
(43) Pub. Date: Sep. 3, 2026

(54) FLEXIBLE SURFACE PLASMON RESONANCE (SPR) SENSOR CHIP AND METHODS FOR MAKING AND USING THE SENSOR

(71) Applicant: Oregon State University, Corvallis, OR (US)

(72) Inventors: Yadvendra Singh, Corvallis, OR (US); Harish Subbaraman, Corvallis, OR (US); Sagar Kumar Verma, Corvallis, OR (US); Nirmala Kandadai, Corvallis, OR (US)

(73) Assignee: Oregon State University, Corvallis, OR (US)

(21) Appl. No.: 19/539,934

(22) Filed: Feb. 13, 2026

Related U.S. Application Data
(60) Provisional application No. 63/761,017, filed on Feb. 20, 2025.

(51) Int. Cl. G01N 21/552; G01N 21/41

(52) U.S. Cl. CPC G01N 21/554; G01N 21/41

(57) ABSTRACT

Disclosed herein are aspects of a flexible surface plasmon resonance (SPR) chip and a sensor comprising the chip. The surface of the SPR chip may be further functionalized to provide or enhance selectivity and/or sensitivity to a desired analyte. In some aspects, the chip comprises a polyimide substrate and a plasmonic metal layer on the substrate. The plasmonic metal layer may be further functionalized. Also disclosed are methods for making and using the SPR chip.

### CROSS REFERENCE TO RELATED APPLICATION

This application claims the benefit of the earlier filing date of U.S. provisional patent application No. 63/761,017, filed on Feb. 20, 2025, which is incorporated herein by reference in its entirety.

### ACKNOWLEDGMENT OF GOVERNMENT SUPPORT

This invention was made with government support under agreement number FA8650-20-2-5506 awarded by the United States Air Force. The government has certain rights in the invention.

### FIELD

The disclosed technology concerns a flexible surface plasmon resonance sensor chip and methods for making and using the chip.

### BACKGROUND

Surface Plasmon Resonance (SPR) is a quantum electromagnetic phenomenon arising from the interaction of light with free electrons at a metal-dielectric interface, emerging as a longitudinal EM wave in a two-dimensional gas of charged particles, such as free electrons in metals. Under certain conditions, the energy carried by the photons is transferred to collective excitations of free electrons, called surface plasmons (SPs), at that interface. This energy transfer occurs only at a specific wavelength of light when the momentum of the photon matches the momentum of the plasmon (resonance condition). The SPs excited are strongly localized across the interface and may be considered electromagnetic (EM) surface waves that propagate along the interface and decay exponentially with distance normal to the interface into the metal. SPR is responsible for a dip in reflectance at the specific wavelength; the dip resulting from the absorption of the optical energy in the metals. Since SP waves are tightly bound to the metal-dielectric interface, penetrating around few tens of nm into the metal (the so-called skin-depth) and typically more than 100 nm into the dielectric (depending on the wavelength), they concentrate EM waves in a region that is considerably smaller than their wavelength.

### SUMMARY

Disclosed herein are aspects of a large area flexible surface plasmon resonance sensor, comprising a flexible substrate having a first surface and a second surface, and a plasmonic metal layer in direct physical contact with the first surface of the flexible substrate. The plasmonic metal layer has a metal layer thickness of from greater than zero to 60 nm, such as from 15 nm to 50 nm, from 25 nm to 50 nm, or from 30 nm to 45 nm. And/or in some aspects, the flexible substrate is a polyimide.

In some aspects, the flexible surface plasmon resonance sensor does not comprise an adhesion layer between the substrate and the plasmonic metal layer.

The flexible substrate may have a substrate thickness of from 20 μm to 500 μm, such as from 50 μm to 150 μm. Additionally, or alternatively, the substrate may have a refractive index of from 1.5 to 1.8 at 633 nm, such as from 1.6 to 1.8 at 633 nm, or from 1.7 to 1.77 at 633 nm.

In some aspects, the metal is gold, silver, copper, or a combination thereof. In certain aspects, the metal is gold.

In some aspects, the sensor and the substrate are both sufficiently flexible to be able to form a bend having a diameter of up to 1 mm without forming a crease or cracking either the substrate or the metal layer.

The metal layer has a first surface and a second surface and the first surface of the metal layer is in direct physical contact with the first surface of the substrate and the second surface of the metal layer is functionalized to be selective for one or more analytes.

In some aspects, the substrate comprises a second surface comprises a prism in contact with or adjacent to the second surface. The prism may be in direct physical contact with the second surface. Or alternatively, the prism may be separated from the second surface by a fluid layer. Typically, the fluid layer prevents there from being an air gap between the prism and the second surface. And in some aspects, the fluid layer has a thickness of from greater than zero to 2 nm, such as from 1 nm to 2 nm. And/or the fluid may have a refractive index within about 1% of the refractive index of the flexible substrate.

Also disclosed herein are aspects of a method for making the sensor disclosed herein. In some aspects, the method comprises providing a flexible substrate having a first surface, cleaning the first surface of the substrate, and depositing a flexible metal layer on the first surface of the substrate. The method may further comprise cutting the flexible substrate to form a sensor of a smaller, desired size.

In any aspects, depositing the flexible metal layer may be performed by thermal chemical vapor deposition (CVD), physical vapor deposition (PVD), RF sputtering, atomic layer deposition (ALD), plasma-enhanced chemical vapor deposition (PE-CVD), or plasma-activated chemical vapor deposition (PACVD).

In some aspects, the method further comprises heating the substrate after depositing the metal layer. Heating the substrate may comprise heating to a temperature of from 70° C. to 100° C., such as from 75° C. to 90° C.

A method for using the disclosed sensor also is disclosed herein. In some aspects, the method comprises exposing the metal layer of a sensor disclosed herein to an analyte, the metal layer being located on the first surface of the flexible substrate, exposing the second surface of the flexible substrate of the sensor to light, and determining the wavelength of the SPR dip. And the method may further comprise contacting the second surface of the substrate with a prism, and wherein exposing the second surface of the flexible substrate of the sensor to light comprises exposing the prism to the light. In some aspects, the light comprises visible and infrared light. In other aspects, the light has a wavelength of from 200 nm to 2200 nm, such as from 300 nm to 1800 nm.

The foregoing and other objects, features, and advantages of the disclosure will become more apparent from the following detailed description, which proceeds with reference to the accompanying figures.

### BRIEF DESCRIPTION OF THE DRAWINGS

FIG. 1 is a schematic diagram of a prior art surface plasmonic resonance (SPR) device, and illustrating how the device enhances the wave vector to excite the SP wave.

FIG. 2 is a schematic diagram of a second prior art SPR device, illustrating how this device enhances the wave vector to excite the SP wave.

FIG. 3 is a schematic diagram illustrating the structure of a prior art SPR device comprising a glass substrate.

FIG. 4 is a schematic diagram illustrating how the prior art glass-based SPR device is attached to a prism using a refractive index fluid.

FIG. 5 is a flow chart illustrating an aspect of the method for making the disclosed large area flexible SPR sensor.

FIG. 6 is a graph of refractive index versus wavelength, illustrating the refractive indices (RIs) of various possible substrates.

FIG. 7 is a schematic diagram for the simulation analysis of the effect of a material's RI on SPR.

FIG. 8 is a graph of reflectance/transmittance versus wavelength, illustrating the numerically calculated TM reflection and transmission spectrum for different materials with Ag in the Kretschmann configuration with DI water as an analyte.

FIG. 9 is a graph of reflectance/transmittance versus wavelength, illustrating the numerically calculated TM reflection and transmission spectrum for different materials with Au in the Kretschmann configuration with DI water as an analyte.

FIG. 10 is a graph of electric field enhancement versus distance, illustrating the numerically calculated electric field enhancement for Kapton and SF11 with Ag.

FIG. 11 is a graph of electric field enhancement versus distance, illustrating the numerically calculated electric field enhancement for Kapton and SF11 with Au.

FIG. 12 is a graph of reflection versus wavelength, illustrating the experimentally calculated TM reflectivity using a developed flexible SPR chip in the Kretschmann configuration with DI water as an analyte.

FIG. 13 is a schematic diagram illustrating an exemplary fabricated flexible SPR chip.

FIG. 14 is a schematic diagram illustrating an exemplary aspect of how the disclosed flexible SPR chip and a coupling prism may be used as a refractive index sensor.

FIG. 15 is a graph of transmitted power versus wavelength, illustrating the calculated TM reflectivity using a developed flexible SPR chip in the Kretschmann configuration as a refractive index sensor in the NIR region.

FIG. 16 is a graph of transmitted power versus wavelength, illustrating the experimentally calculated TE and TM reflectivity using a developed flexible SPR chip in the Kretschmann configuration with DI water as an analyte in the NIR region.

FIG. 17 is a graph of transmitted power versus wavelength, illustrating the experimentally calculated TE and TM reflectivity using a developed flexible SPR chip in the Kretschmann configuration as a refractive index sensor in the NIR region.

FIG. 18 is a flow chart illustrating one aspect of a method for functionalizing the SPR chip.

FIG. 19 is a schematic diagram illustrating an exemplary aspect of how the disclosed 2D material-based flexible SPR sensing chip and coupling prism may be used as a refractive index sensor.

FIG. 20 is a schematic diagram illustrating an exemplary aspect of how the disclosed 2D material-based flexible SPR sensing chip with a Bio Recognition Element (BRE) layer for biosensors.

FIG. 21 is a graph of reflectance versus wavelength, illustrating the sensing performance of an Ag-coated flexible SPR chip before graphene transfer.

FIG. 22 is a graph of resonance wavelength versus refractive index, illustrating the sensing performance of an Ag-coated flexible SPR chip before graphene transfer.

FIG. 23 is a graph of reflectance versus wavelength, illustrating the sensing performance of an Ag-coated flexible SPR chip after graphene transfer.

FIG. 24 is a graph of resonance wavelength versus refractive index, illustrating the sensing performance of an Ag-coated flexible SPR chip after graphene transfer.

FIG. 25 is a schematic diagram illustrating an exemplary aspect of the method used to functionalize a disclosed flexible SPR chip.

FIG. 26 is a graph of reflectance versus wavelength illustrating the sensing performance of an Au-coated flexible SPR chip before graphene transfer.

FIG. 27 is a graph of reflectance versus wavelength illustrating the sensing performance of an Au-coated flexible SPR chip after graphene transfer and functionalize with GOx.

FIG. 28 is a graph of resonance wavelength versus concentration, illustrating the selectivity of the GOx sensor when exposed to interferent compounds having concentrations of 8 mM.

FIG. 29 is a bar graph illustrating the selectivity of the GOx sensor when exposed to interferent compounds having concentrations of 8 mM.

### DETAILED DESCRIPTION

### I. TERMS

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

Although the steps of some of the disclosed methods are described in a particular, sequential order for convenient presentation, it should be understood that this manner of description encompasses rearrangement, unless a particular ordering is required by specific language set forth below. For example, steps described sequentially may in some cases be rearranged or performed concurrently. Additionally, the description sometimes uses terms like “produce” or “provide” to describe the disclosed methods. These terms are high-level abstractions of the actual steps that are performed. The actual steps that correspond to these terms will vary depending on the particular implementation and are readily discernible by one of ordinary skill in the art.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods and in some aspects encompasses a range up to ±15% of that numerical value, unless the context clearly dictates otherwise. When directly and explicitly distinguishing aspects from discussed prior art, the aspect numbers are not approximates unless the word “about” is recited. Furthermore, not all alternatives recited herein are equivalents.

### II. INTRODUCTION

There are two types of SPs with respect to their propagation characteristics along the interface: (a) extended or propagating; and (b) localized. Propagating SPs have been studied for a long time. However, the latest advancements in nanotechnology have made fabrication of structures with nanometer scale features possible, thereby enabling localized SPR to become a subject of immense interest over the last two decades. Localized SPs are excited in metallic structures with lateral dimensions of less than half the wavelength of the exciting EM wave. A third type of plasmon called long-range SPR (LRSPR) exists in thin metal films or strips characterized by low attenuation and travel along the surface for distances up to few millimetres in visible light to few centimetres in infrared light.

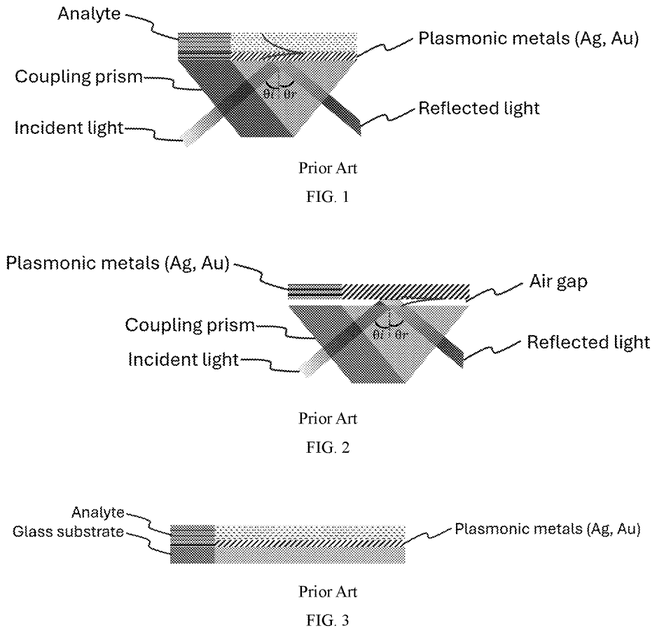

In the case of propagating SPR (PSPR), plasmons propagate along the interface between metal and dielectric for distances on the order of microns to tens and even hundreds of microns and decay evanescently in the z-direction (FIGS. 1 and 2). In FIGS. 1 and 2 the plasmons propagate along to the interface of metal and dielectric with 1/e decay length on the order of half the wavelength (about 200 nm for wavelengths in visible range). The interaction between the metal surface-confined EM waves and the molecular layer of interest leads to shifts in the plasmon resonance, which can be observed in three main modes: (a) angle interrogation mode, (b) wavelength interrogation mode, and (c) imaging mode. In the first two modes, the reflectivity of light is measured from the metal surface as a function of either wavelength (at constant incident angle) or as a function of incident angle (at constant wavelength). The third mode uses light of both constant wavelength and incident angle to interrogate a two-dimensional region of the sample, mapping the reflectivity of the sample as a function of position. In each of these modes, intensity, phase, and/or polarization changes can be measured.

PSPR biosensors have been widely applied in a diverse range of fields, including molecular recognition, disease immunoassays, etc. Even though these conventional SPR bio-sensors are more sensitive than other label-free devices, they can still not directly detect small molecular concentrations (physiological concentration) on the surface of the bio-sensor. Consequently, various proposals have been developed to enhance the sensitivity or resolution of bio-sensors by using different SPR modes or detection methods. Also, various localized SPR (LSPR) biosensors have been proposed, which employ the strong UV-Vis absorption band of the metal nanoparticles to yield an area mass detection limit of 100-1000 pg/mm². However, this detection capability is poorer than conventional PSPR biosensors by an order of 10-100 times.

FIGS. 1 and 2 schematically shows several techniques for enhancing the wavevector to excite the SP wave. FIG. 1 shows prism coupling on the top of the metallic film, in which the prism refractive index enhances the wave vector. This method is known as the Kretschmann configuration. FIG. 1 illustrates the incident light, reflected light, plasmonic metal film, analyte, and coupling prism. The electric field distribution on the metal-dielectric interface is shown symbolically. FIG. 2 illustrates the Otto configuration of the prism-based SPR sensor in which a thin air gap separates the coupling prism and plasmonic metal layer. This thin air gap is filled with the analyte when used for sensing purposes. In this configuration, the wave vector is enhanced by the prism refractive index, and the coupling occurs via evanescent waves since the air gap is thinner than the light penetration depth. FIG. 2 illustrates the incident light, reflected light, air gap, plasmonic metal, coupling prism, and the electric field distribution.

Any change in the analyte refractive index provides a change in the incident light wave vector and, consequently, a shift in the resonance angle at a fixed wavelength or a change in the resonance wavelength for a fixed incident angle because the prism wave vector along the interface is:

$${k}_{x} = \frac{2 π \sqrt{{ε}_{p}}}{λ} sin {θ}_{p}$$

where εₚ is the dielectric constant of the prism, θₚ is the incident beam angle at the prism-metal interface, and λ is the wavelength of incident light. In the Kretschmann configuration, a prism is required to excite the plasmons by transverse magnetic (TM) polarized coherent light. The excited plasmons help to match the wave vector of the incident light along the interface and the wave vector of the surface plasmons. This matching condition is called phase matching condition and is represented as:

$${\underbrace{{k}_{0} \sqrt{{ε}_{p}} sin {θ}_{p}}}_{wave vector of the incident light} = {\underbrace{{k}_{0} Re \{ \sqrt{\frac{{ε}_{m} {ε}_{a}}{{ε}_{m} + {ε}_{a}}} \}}}_{wave vector of the surface plasmons}$$

where εₚ is the dielectric constant of the prism, θₚ is the incident beam angle at the prism-metal interface. εₘ and εₐ are the complex dielectric constants of the metal and analyte, respectively. As per the above equation, the SP can be excited at a specific angle depending on the wavelength of light through the material dispersion relation. The most popular and accurate PSR sensing scheme uses the prism coupling in the Kretschmann-Raether (KR) arrangement, as shown in FIG. 1. In KR configuration, where reflectivity is measured as a function of incident angle, the method is known as the angular interrogation method, and where reflectivity is measured as a function of wavelength, the method is known as wavelength interrogation. In the angular interrogation method, a collimated beam of single wavelength is applied to the metal film through the prism while scanning through different incidence angles. The SPR dip is observed in the reflectivity versus incident angle spectrum of the collimated beam. While in wavelength interrogation method, a collimated beam of multiple wavelengths from broad-band light source is applied to the metal film through the prism at a fixed incident angle (greater than the critical angle). In this case, the SPR dip is observed in the reflectivity versus wavelength spectrum of the collimated beam.

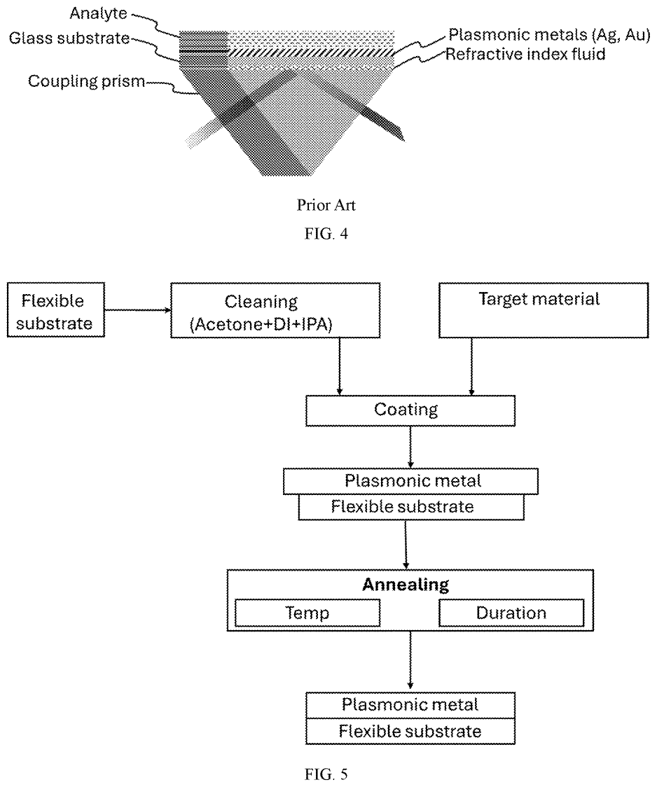

Recently all prism-based SPR sensors used thick glass-based SPR chips, which are coated with plasmonic metal, as shown in FIG. 3 and applied to the flat surface of the prism with the help of refractive index matching liquid as shown in FIG. 4. In every prism-based SPR sensing, the refractive index matching liquid helps maintain consistent optical contact between the prism and the metal layer, which is crucial for repeatable and reliable measurements. Air gaps or imperfections at the interface could lead to signal degradation or inaccuracies. The refractive index matching liquid's refractive index is chosen to closely match or be slightly lower than that of the prism material. This minimizes reflection losses at the prism-metal interface and allows efficient transfer of light energy to the metal layer for surface plasmon excitation. Typically, the refractive index of the liquid is within 1% of the refractive index of the prism, such as from having the same refractive index as the prism to being up to 1% less that the refractive index of the prism. Exemplary refractive index liquids include, but are not limited to, Series AAA n_{D} 1.300-1.395±0.0002 (589.3 nm, 25.0° C.), Series AA n_{D} 1.400-1.458±0.0002 (589.3 nm, 25.0° C.), Series A n_{D} 1.460-1.640±0.0002 (589.3 nm, 25.0° C.), Series B n_{D} 1.642-1.700±0.0002 (589.3 nm, 25.0° C.), Series M n_{D} 1.705-1.800±0.0005 (589.3 nm, 25.0° C.), and Series E n_{D} 1.500-1.640±0.0005 (589.3 nm, 25.0° C.) available from Cargille Laboratories.

These glass-based SPR chips have some limitations, such as rigidness, high-cost, fabrication complexity, and low reusability with cleaning due to high cost of cleaning. Also, it is difficult to produce small chips from large area coated glass substrates, hence most SPR chips are fabricated in batches over small glass chips.

Chang et al. (Nature scientific reports, 2018, vol. 8: 11812; hereafter Chang) discloses forming a surface plasmon resonance sensor. However, Chang uses multiple layers of plasmonic metal, separated by SiO₂ layers. Additionally, Chang requires an SiNₓ adhesion layer to attach the first layer of plasmonic material to the substrate. While flexible SPR sensor operate efficiently over a broader range of refractive index changes compared to LSPR sensors, making them suitable for diverse applications such as biosensing, chemical sensing, and environmental monitoring. The developed flexible SPR sensors disclosed herein typically have a larger sensing area compared to LSPR, which enhances the probability of analyte interaction and improves detection efficiency in low-concentration scenarios.

Lin et al. (Applied Materials and Interfaces, 2021, vol. 13, pages 11369-11384; hereafter Lin) discloses inkjet printing of metal electrodes onto a Kapton® substrate. In addition to the troublesome pretreatments used during the manufacturing process of inkjet-printing technologies, many reported post treatments related to metal ink sintering, such as laser sintering, ohmic curing, microwave sintering, and infrared sintering, are also very expensive and time-consuming. However, the electronic transducer system has very high power loss and needs to be compensated with amplifiers. In contrast, the disclosed SPR sensor utilizes substantially pure (99.999%) Au and Ag metal by deposition methods that provides a highly uniform and impurity-free thin metal film to the Kapton. This is not possible with any printing techniques. Printing techniques, such as the inkjet printing disclosed by Lin, produce printed films that are too think to be used for plasmonics. Hence Lin produces electronic sensors on the flexible substrate, and not an optical sensor such as the SPR optical sensors disclosed herein.

Supriya and Claus disclose a solution-based assembly of conductive gold film on flexible polymer substrates (Langmuir 2004, vol. 20, No. 20, pages 8870-8876; hereafter referred to as Supriya). However, Supriya requires an adhesive silane layer between the polymer substrate and the gold layer. Supriya then deposits colloidal gold particles on the adhesive layer to form a gold film having a surface roughness of Rₐ=15 nm as measured over a 5×5 μm area. Although, they used the colloidal solution of the gold, hence this method highly dependent on the adhesive silane site on the polymer substrate. The initial coverage of gold particles is not dense enough to form a conductive film directly after self-assembly, necessitating additional seeding steps to improve coverage. Prolonged deposition times can lead to the formation of physiosorbed multilayers, which hinder the attachment of gold nanoparticles. This affects the overall quality and uniformity of the gold films. These limitations highlight areas where further optimization (e.g., better silane coupling methods, improved control over particle deposition, or alternative surface treatments) may be required to enhance the performance and reliability of the conductive gold films. Hence, the method of Supriya is not suitable to make the disclosed SPR sensor.

### III. FLEXIBLE SPR CHIP

The purpose of the present disclosure is to provide a new flexible SPR sensor chip that will be cost-effective, facilitate large-area fabrication, and lighter weight than the previous SPR sensor chips. The development of flexible SPR sensors involves innovative materials that can maintain the integrity and functionality of the plasmonic surface while being bendable. Materials like thin gold/silver films on a polyimide (e.g. Kapton®) or PET flexible substrates are used in this innovation. It can also be used to develop large-area SPR-based chemicals and biosensors. Moreover, smaller chips can be easily generated from a large area coating by simply cutting the large, coated substrate to a desired size, such as by using scissors or a blade. One of the most promising applications of flexible SPR sensors is in the field of wearable health monitoring devices. They can also be used to continuously monitor physiological parameters or detect specific biomarkers in bodily fluids. Their flexibility allows for easy integration into various environmental systems, making them suitable for real-time monitoring of pollutants or other environmental parameters, for example, in a wearable device.

FIGS. 3 and 4 show the traditional prism-based SPR sensor using the Kretschmann configuration in which the SPR sensor chip is developed on the rigid glass substrate. These traditional SPR sensor chips are typically rigid and limited in their application. Like their rigid counterparts, flexible SPR sensors are highly sensitive and can detect minute changes in the refractive index of a surrounding medium. This makes them suitable for detecting various biological and chemical interactions. Introducing flexibility into SPR sensors adds a new dimension to this technology. Flexible SPR sensors, on the other hand, can be integrated into various surfaces and environments where rigid sensors cannot be used. This flexibility opens up many new applications, especially in wearable technologies, biomedical devices, and environmental monitoring.

### A. Substrate

Disclosed herein are aspects of a flexible SPR chip comprising a plasmonic metal layer on a flexible substrate. The flexible substrate may be any flexible substrate, such as a Kapton® (polyimide) or polyethylene terephthalate (PET) substrate. In some aspects, the substrate is a Kapton® substrate. And the plasmonic metal may be any plasmonic metal suitable for depositing onto the substrate, such as Cu, Ag, Au, or combinations thereof.

In some aspects, the substrate has a thickness of from greater than zero to 1,000 μm or more, such as from 10 μm to 1,000 μm, from 20 μm to 750 μm, from 20 μm to 500 μm, from 50 μm to 250 μm, from 50 μm to 150 μm, or from 100 μm to 150 μm. In certain aspects, the substrate has a thickness of 110 μm to 104 μm, from 120 μm to 130 μm, or about 125 μm.

In some aspects, the substrate is a flexible substrate. As used herein, a flexible substrate is a substrate that is able to form a bend of up to 1 mm in diameter without forming a crease or cracking.

i. Kapton® Substrate

Kapton® sheets, made from polyimide film, are highly regarded for their unique set of properties, making them ideal for the disclosed application. During manufacture of a SPR chip, the chip is treated with a variety of chemicals and is exposed to several different temperatures, depending on the nature of the eventual application, for example, a chemical or biochemical sensor. Here are some of the useful advantages of using Kapton® sheets as the substrate for the disclosed SPR chips.
a. Kapton® sheets can withstand extreme temperatures, from as low as −269° C. (−452° F.) up to +400° C. (+752° F.), without losing its structural integrity. This makes it ideal for applications in aerospace, electronics, and other fields where exposure to extreme temperatures is common.
b. Kapton® is an excellent electrical insulator, even at high temperatures, making it widely used in electronics as insulation tape, wire insulation, and flexible circuits. Hence, it will act as a dielectric in the disclosed chip, which will not be affected by electric or magnetic fields.
c. Kapton® is resistant to many chemicals, including oils, solvents, and fuels, making it suitable for use in environments exposed to potentially corrosive substances. It has a very low coefficient of thermal expansion, which ensures minimal dimensional changes even under fluctuating temperatures. This makes Kapton® sheet a good choice for applications where precise tolerances are essential.
d. Kapton® sheets have a high tensile strength, which makes them durable and able to withstand mechanical stress and wear over time, especially useful in high-stress environments. Despite its strength, Kapton® is lightweight and flexible, allowing it to be used in designs requiring pliability, such as flexible printed circuit boards, wearable sensors, and other applications where space and weight savings are important.
e. Other than these physical properties, Kapton® has a refractive index of 1.7445 at 633 nm, which is very closer to the SF11 prism refractive index of 1.7786 at 633 nm. The refractive index properties of Kapton® are discussed in more detail below. Additionally, Kapton® is also transparent within the visible region as compared to the other polymer materials, which makes it advantageous for many sensor applications, such as the applications described herein.

Currently, no other polymer completes the Kapton® substrate in physical and optical properties to handle the chemical processes that apply to the substrate during the sensor fabrication.

ii. Refractive Index

In some aspects, the substrate is selected to have a refractive index that is close to the refractive index of the prism that is used to read the sensor. Typically, an SF11 prism is used that has a refractive index of 1.7786 at 633 nm. In some aspects, the substrate has a refractive index of from 1.5 to 1.8 or more at 633 nm, such as from 1.55 to 1.8 at 633 nm, from 1.6 to 1.8 at 633 nm, from 1.65 to 1.8 at 633 nm, from 1.7 to 1.8 at 633 nm, from 1.7 to 1.77 at 633 nm, or from 1.72 to 1.75 at 633 nm.

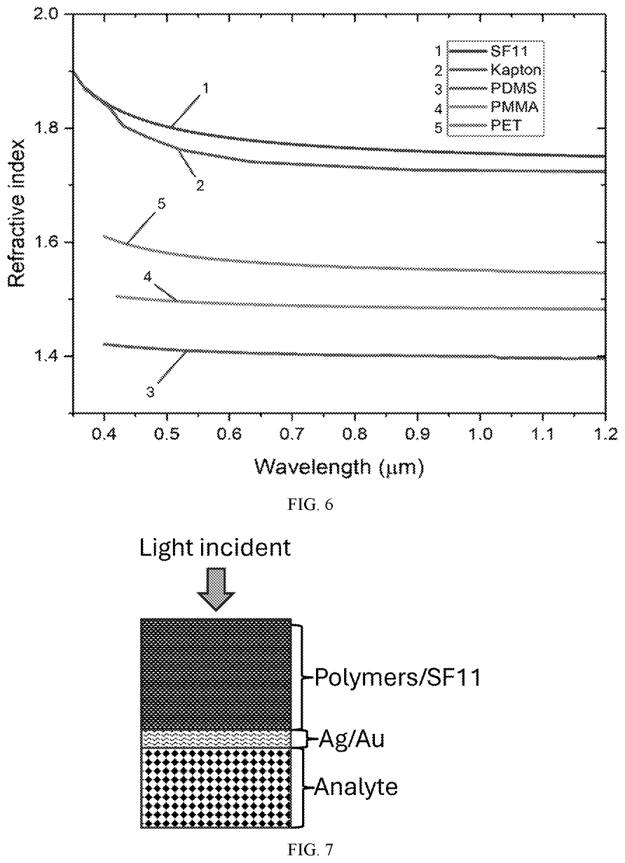

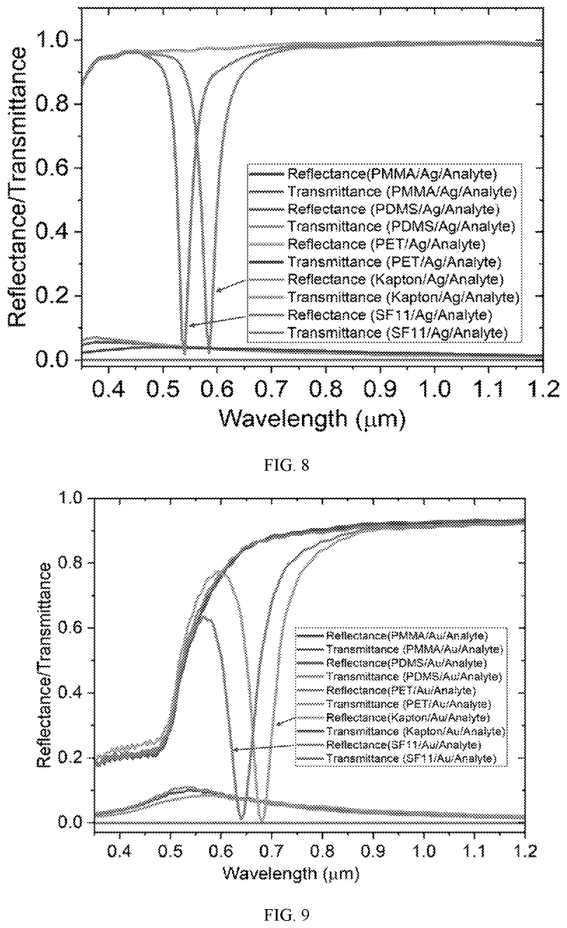

Experimental values of the refractive index (RI) of different polymers were considered: Polymethyl methacrylate (PMMA), Polydimethylsiloxane (PDMS), Polyethylene terephthalate (PET), and polyimide Kapton®. The experimental values of the refractive indices of these polymers were obtained from the literature. The RI's of all these materials and SF11, which is a typical prism material, is provided in FIG. 6 for a 0.3 μm to 1.2 μm wavelength range. FIG. 6 demonstrates that Kapton®'s refractive index is very similar to the SF11 prism material. A simulation study using COMSOL Multiphysics software was performed to estimate the effect of the material's RI on SPR. FIG. 7 provides a schematic of the simulated structure. In the simulated study, a TM-polarized light was assumed to be applied from the top side at a fixed incident angle, and the reflectance and the transmission were calculated. The entire analysis was done with silver (Ag) and gold (Au) as the plasmonic metal. Ag and Au refractive indices were taken from Johnson and Christy (Optical constants of the noble metals, Phys. Rev. B 6, 4370-4379 (1972)). FIGS. 8 and 9 provide the calculated reflection and transmission spectrum of the plasmonic structure with different materials for Ag and Au, respectively. FIG. 8 shows that only SF11 glass and Kapton® sheet show a sharp dip at 540 nm and 585 nm, respectively, with Ag in the reflection spectrum due to the phase-matching condition of the wave vector. Similarly, FIG. 9 shows that only SF11 glass and Kapton sheet show a sharp dip at 642 nm and 680 nm, respectively, with Au in the reflection spectrum. Other polymer materials such as PMMA, PDMS, and PET did not show any dip in the reflection spectrum. These data demonstrate that to achieve a phase-matching condition, the RI of the sensor substrate and prism materials needs to be as close as possible to the SF11 glass prism.

Typically, conventional prism-based sensors use a thick glass substrate (about 1 mm) to prepare an SPR chip. The Kapton® sheets used herein are very thin, typically about 127 μm, with the silver and/or gold layer applied on top. Because the thickness of the sheet is so thin, the difference between the refractive indices of the prism and the Kapton® sheet does not affect the phase-matching condition.

iii. Electric-Field Enhancement

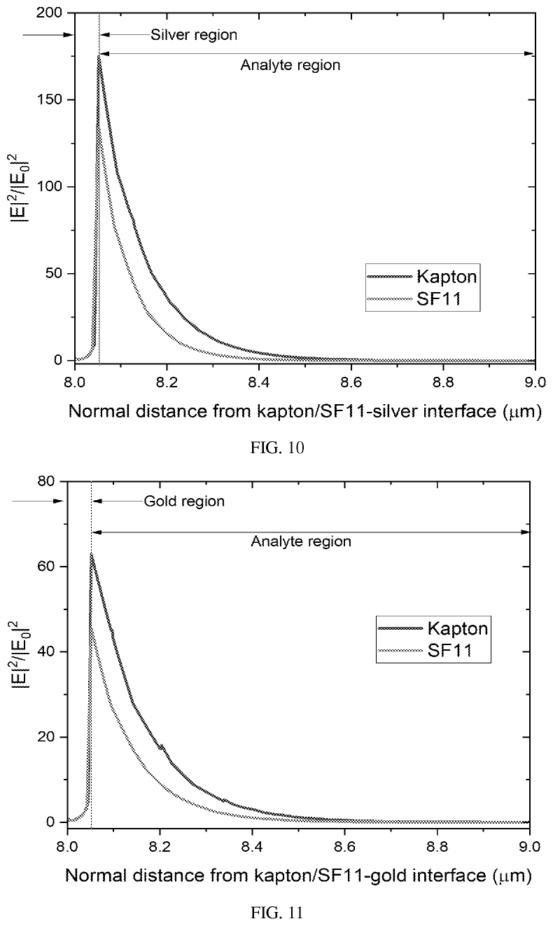

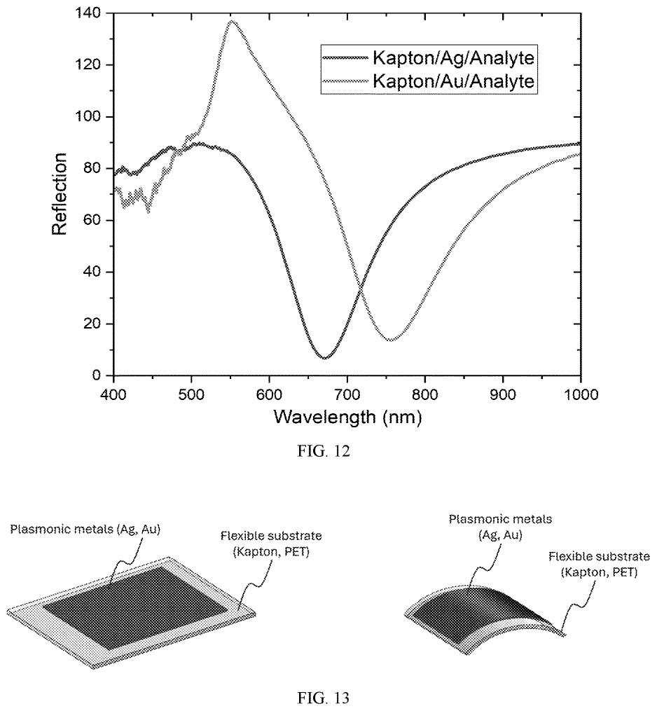

An additional advantage of the Kapton®-based SPR chip over the SF11 glass-based SPR chip is that electric-field enhancement (EFE) is higher with Kapton® than with SF11 glass, as shown in FIGS. 10 and 11. The calculated electric field enhancements were 134 and 175 with Ag plasmonic material for SF11 and Kapton®, respectively, as shown in FIG. 10. And electric field enhancements of 45.6 and 63.2 were calculated with Au plasmonic material for SF11 and Kapton®, respectively as shown in FIG. 11. These data illustrated that Kapton®'s electric field enhancement was about 30.6% higher (with Ag) and 38.6% higher (with Au) compared to the SF11 glass substrate. Higher electric field enhancement provides a better coupling between the incident light wave vector and the SP wave vector and is important for analyte- or bio-sensing. Hence, the solid SF11 glass-based SPR chip can be replaced with a flexible and very thin Kapton®-based SPR chip, where other flexible polymeric materials would fail. The experimental results demonstrated that a flexible Kapton-based SPR chip works with Ag and Au, as shown in FIG. 12.

### B. SPR Chip

FIG. 5 provides a flow chart illustrating the method for making the disclosed flexible SPR chip. With reference to FIG. 5, before the metal is applied to the flexible substrate, the substrate (for example, Kapton® or PET) is cleaned with DI water, followed by acetone, isopropanol (IPA), and dried with nitrogen. After cleaning, plasma treatment is applied to the Kapton substrate to increase the adhesion between the metal and the Kapton substrate. In some aspects, plasma treatment further cleans the substrate thereby facilitating deposition of the plasmonic material. Typically, the plasma treatment does not modify the structure of the substrate surface. However, the disclosed SPR chip does not comprise an adhesive layer between the substrate and the plasmonic material. Rather, the plasmonic metal layer is deposited directly onto the surface of the substrate.

The plasmonic material is deposited onto the substrate surface by any suitable technique, such as thermal chemical vapor deposition (CVD), physical vapor deposition (PVD), RF sputtering, atomic layer deposition (ALD), plasma-enhanced chemical vapor deposition (PE-CVD), or plasma-activated chemical vapor deposition (PACVD). In some aspects, the plasmonic material is deposited to form a layer having a thickness of from 15 nm to 70 nm, such as from 15 nm to 50 nm, from 20 nm to 70 nm, from 25 nm to 70 nm, from 30 nm to 60 nm, from 30 nm to 55 nm, from 30 nm to 45 nm, or from 40 nm to 55 nm.

In some aspects, the SPR chip includes only a single layer of the plasmonic material. That is, the chip does not comprise a second plasmonic layer deposited on top of the first plasmonic layer with a separating layer of a different material (for example a silica layer) in between the two or more plasmonic layers.

In some aspects, after deposition the substrate with the deposited plasmonic material is annealed. Annealing may facilitate a roughness-free surface on the flexible SPR chip. In some aspects, the surface has a surface roughness value (R_{RMS}) of 8 nm or less, such as from 0 to less than 8 nm. Annealing may be performed at a temperature suitable to provide a desired roughness-value. In some aspects, annealing is performed by heating the substrate to a temperature of from 60° C. to 100° C., such as from 70° C. to 100° C., from 70° C. to 90° C., from 75° C. to 90° C., or about 80° C., and may be performed for a time period of from 10 minutes to 60 minutes, such as from 10 minutes to 45 minutes, from 10 minutes to 30 minutes, or from 10 minutes to 20 minutes.

A schematic of a fabricated flexible SPR chip is shown in FIG. 13. The method disclosed herein supports large-area fabrication. As the fabricated chip is on a polyimide substrate, it can be cut into different sizes and can be used as a different sensor or can be used to check the repeatability of the sensor.

In some aspects, the fabricated chip has an area of from 0.25 mm² to 100 cm² (for example, from 0.5 mm×0.5 mm or 1 mm×25 mm to 10 cm×10 cm or 5 cm×20 cm), such as from 1 mm² to 100 cm², from 5 mm² to 100 cm², from 25 mm² to 100 cm², from 1 cm² to 100 cm², from 10 cm² to 100 cm², from 25 cm² to 100 cm², from 25 cm² to 50 cm², or from 50 cm² to 100 cm².

In some aspects, the chip is fabricated in a large area, for example, but not limited to, from 1 cm² to 100 cm², from 10 cm² to 100 cm², from 25 cm² to 100 cm², from 25 cm² to 50 cm², or from 50 cm² to 100 cm² and then cut to a smaller, desired size (for example, but not limited to, from 0.25 mm² to 10 cm², from 0.25 mm² to 1 cm², or from 1 mm² to 1 cm²).

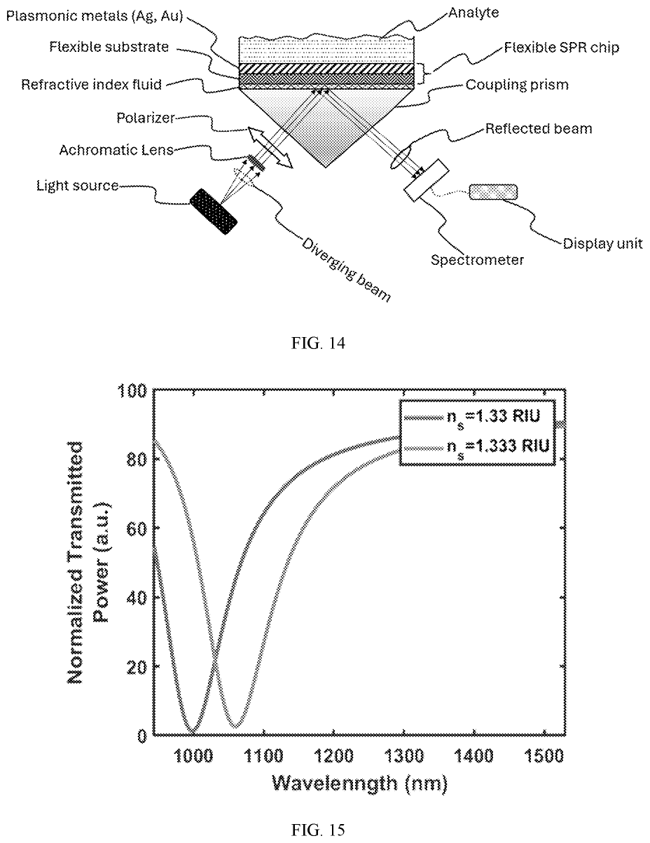

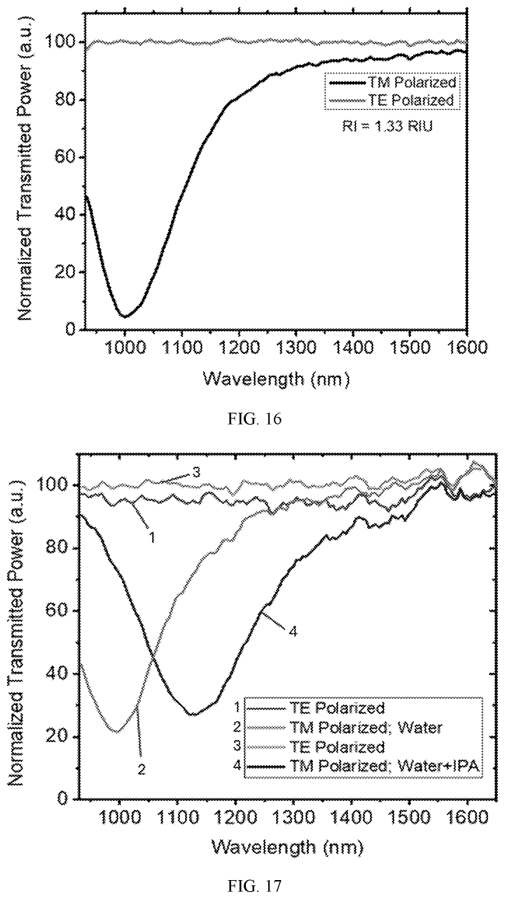

For sensing an analyte refractive index using the disclosed flexible SPR chip, an SF11 prism is used as a light coupling medium, as shown in FIG. 14. With respect to FIG. 14, a refractive index matching liquid may be used between the coupling prism and the flexible SPR chip to increase the reusability of the developed flexible SPR chip. A refractive index matching liquid provides a continuous path for the incident light through the coupling prism to the flexible SPR chip without any air gap. A broadband light source with multiple wavelengths, for example, from 200 nm to 2200 nm, is used as light input to the device. The light beam coming from the light source is diverging in nature hence, an achromatic lens is used to collimate the diverging beam. The collimated light beam passes through the polarizer, which converts the collimated unpolarized light to collimated TE/TM polarized light before entering the coupling prism. The TE-polarized collimated beam is reflected from the upper surface where a flexible SPR sensor chip has been placed after attenuated total reflection (ATR). The reflected beam through the prism is collected to the spectrometer, which is also connected to the display unit. The reflected light intensity with respect to the wavelengths is plotted on the display unit. No dip appears in the reflection spectrum when the analyte is not placed on the flexible SPR chip. As a water-based analyte is applied to the SPR chip, a dip appears in the reflection spectrum, as shown in FIG. 16. The wavelength where a minimum reflectance is achieved is called the resonance wavelength. This resonance wavelength is highly dependent on the analyte refractive index. The resonance wavelength shifts to a higher wavelength when the analyte's refractive index (5% ethanol is mixed in DI water) changes, as shown in FIG. 17.

### C. Functionalization

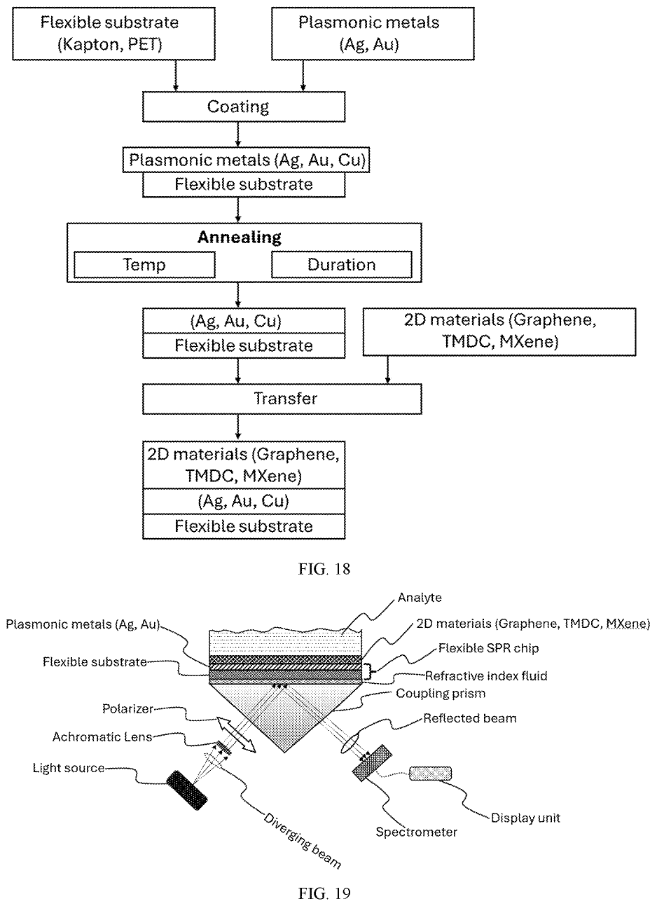

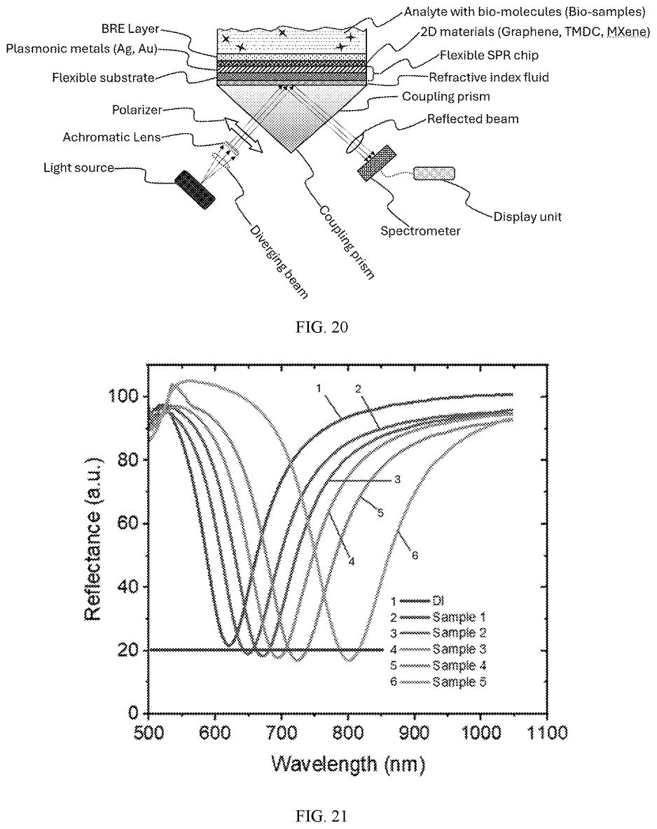

A two-dimensional (2D) material-based flexible SPR chip was developed according to the flow chart shown in FIG. 18. In this method, a flexible SPR chip was fabricated using the same process as in the FIG. 5. The transfer process of the 2D materials on the flexible SPR chip was adapted from literature and is described in the Examples. The setup has been used for chemical sensing with a 2D material-based flexible SPR chip, as shown in the FIG. 19. Suitable two-dimensional (2D) materials include, but are not limited to, graphene, MXenes (atomically thin layers of transition metal carbides, nitrides, or carbonitrides) and transition metal dichalcogenides. Such 2D materials facilitate detection of biomolecules, gases, ions, and photons etc. with good mechanical flexibility. 2D materials also may have unique optical properties which may enhance the light-matter interaction at the sensing layer. Hence, a 2D material-based flexible SPR chip demonstrates enhanced performance. Further, such a sensing chip can be used as a bio-sensor, as shown in FIG. 20, where a biorecognition element (BRE) layer is applied to the upper layer of the 2D material-based flexible SPR chip. The BRE layer is different for different bio-samples, for example, glucose oxidase to detect glucose, and Uricase to detect uric acid in the analyte etc. Below are some exemplary biorecognition elements used in plasmonic biosensors:
1. Antibody-Based Biosensors (Immunosensors)
   Biorecognition Element: Antibodies (monoclonal or polyclonal)
   Target Analytes: Proteins, viruses, bacteria, toxins
   Example: Surface Plasmon Resonance (SPR) biosensors for disease detection
2. Aptamer-Based Biosensors
   Biorecognition Element: Aptamers (short single-stranded DNA or RNA)
   Target Analytes: Small molecules, proteins, pathogens
   Example: SPR-based detection of cancer biomarkers
3. DNA/RNA-Based Biosensors
   Biorecognition Element: Single-stranded DNA/RNA probes
   Target Analytes: Complementary nucleic acid sequences, genetic mutations, pathogens
   Example: Plasmonic biosensors for detecting viral RNA (e.g., SARS-CoV-2 detection)
4. Enzyme-Based Biosensors
   Biorecognition Element: Enzymes (e.g., glucose oxidase, horseradish peroxidase)
   Target Analytes: Glucose, cholesterol, urea
   Example: Enzyme-functionalized plasmonic nanoparticles for glucose sensing
5. Receptor-Based Biosensors
   Biorecognition Element: Cell surface receptors, affinity proteins
   Target Analytes: Hormones, neurotransmitters
   Example: SPR-based detection of hormone levels in biomedical diagnostics
6. Peptide-Based Biosensors
   Biorecognition Element: Synthetic peptides or natural peptides
   Target Analytes: Bacteria, toxins, biomarkers
   Example: Peptide-functionalized plasmonic biosensors for bacterial detection
7. Molecularly Imprinted Polymer (MIP)-Based Biosensors
   Biorecognition Element: Molecularly Imprinted Polymers (MIPs)
   Target Analytes: Small molecules, drugs, toxins
   Example: Plasmonic MIP-based sensors for detecting pharmaceuticals
8. Whole-Cell and Cell Membrane-Based Biosensors
   Biorecognition Element: Whole cells, bacteria, or cell membrane receptors
   Target Analytes: Toxins, pathogens, environmental pollutants
   Example: Plasmonic sensors using bacterial cells for heavy metal detection

Additionally, the disclosed flexible SPR chip can be designed to make it wearable on a human body. The flexible SPR chip has been developed on a tattoo paper, and it contains a plasmonic metal-coated Kapton® sheet, which is applied directly to the skin. To get the reading from the body-worn flexible SPR chip, the tattoo paper is removed and the chip is connected to a custom-made prism coupling setup.

### IV. APPLICATIONS

The disclosed SPR chip is useful as a sensor for a wide variety of chemical and biochemical sensing applications. The SPR chip can be used in any application that an SPR chip and sensor is currently used, such as chemical and biochemical sensing, testing fluids for chemical or biochemical components or contaminants, or environmental sensing, for example, to detect pollutants.

Additionally, the disclosed chip can be fabricated in large sheets and then cut down to a size suitable for a specific application. This enables the disclosed chip to be used in applications that require unusual or non-standard sensor sizes, rather than having to adjust an application based on the available size of a sensor chip. Additionally, the chip and sensor are flexible and, therefore, can be used for applications where the sensor is required to fit a non-flat surface, such as for a device that is designed to be worn by a human or animal subject. Such sensors may be used to provide real-time monitoring of bodily fluids, for example, drug discovery, environmental monitoring, food safety, protein-protein interactions, binding efficiency between antibody and antigen, medical diagnostic such as glucose detection, uric acid detection, etc.

### V. EXEMPLARY ASPECTS

The following numbered paragraphs illustrate exemplary aspects of the disclosed technology.

Paragraph 1. A flexible surface plasmon resonance sensor, comprising:
a flexible substrate having a first surface and a second surface; and
a plasmonic metal layer in direct physical contact with the first surface of the flexible substrate, the plasmonic metal layer having a metal layer thickness of from greater than zero to 60 nm;
wherein the flexible surface plasmon resonance sensor does not comprise an adhesion layer between the substrate and the plasmonic metal layer.

Paragraph 2. The sensor of paragraph 1, wherein the flexible substrate is a polyimide.

Paragraph 3. The sensor of paragraph 1 or paragraph 2, wherein the flexible substrate has a substrate thickness of from 20 μm to 500 μm.

Paragraph 4. The sensor of paragraph 3, wherein the substrate thickness is from 50 μm to 150 μm.

Paragraph 5. The sensor of any one of paragraphs 1-4, wherein the substrate has a refractive index of from 1.5 to 1.8 at 633 nm.

Paragraph 6. The sensor of paragraph 5, wherein the refractive index is from 1.6 to 1.8 at 633 nm.

Paragraph 7. The sensor of paragraph 6, wherein the refractive index is from 1.7 to 1.77 at 633 nm.

Paragraph 8. The sensor of any one of paragraphs 1-7, wherein the metal is gold, silver, copper, or a combination thereof.

Paragraph 9. The sensor of any one of paragraphs 1-8, wherein the metal is gold.

Paragraph 10. The sensor of any one of paragraphs 1-9, wherein the sensor and the substrate are both sufficiently flexible to be able to form a bend having a diameter of up to 1 mm without forming a crease or cracking either the substrate or the metal film.

Paragraph 11. The sensor of any one of paragraphs 1-10, wherein the metal layer thickness is from 15 nm to 50 nm.

Paragraph 12. The sensor of paragraph 11, wherein the metal layer thickness is from 25 nm to 50 nm.

Paragraph 13. The sensor of paragraph 12, wherein the metal layer thickness is from 30 nm to 45 nm.

Paragraph 14. The sensor of any one of paragraphs 1-13, wherein the metal layer has a first surface and a second surface and the first surface of the metal layer is in direct physical contact with the first surface of the substrate and the second surface of the metal layer is functionalized to be selective for one or more analytes.

Paragraph 15. The sensor of any one of paragraphs 1-14, wherein the substrate comprises a second surface comprises a prism in contact with or adjacent to the second surface.

Paragraph 16. The sensor of paragraph 15, wherein the prism is in direct physical contact with the second surface.

Paragraph 17. The sensor of paragraph 15, wherein the prism is separated from the second surface by a fluid layer.

Paragraph 18. The sensor of paragraph 17, wherein the fluid layer prevents there from being an air gap between the prism and the second surface.

Paragraph 19. The sensor of paragraph 17 or paragraph 18, wherein the fluid layer has a thickness of from greater than zero to 2 nm.

Paragraph 20. The sensor of paragraph 17 or paragraph 18, wherein the fluid layer has a thickness of from 1 nm to 2 nm.

Paragraph 21. The sensor of any one of paragraphs 17-20, wherein the fluid has a refractive index within about 1% of the refractive index of the flexible substrate.

Paragraph 22. A method for making the sensor of any one of paragraphs 1-21, the method comprising:
providing a flexible substrate having a first surface;
cleaning the first surface of the substrate; and
depositing a flexible metal layer on the first surface of the substrate.

Paragraph 23. The method of paragraph 22, further comprising cutting the flexible substrate to form a sensor of a smaller, desired size.

Paragraph 24. The method of paragraph 22 or paragraph 23, wherein depositing the flexible metal layer is performed by thermal chemical vapor deposition (CVD), physical vapor deposition (PVD), RF sputtering, atomic layer deposition (ALD), plasma-enhanced chemical vapor deposition (PE-CVD), or plasma-activated chemical vapor deposition (PACVD).

Paragraph 25. The method of any one of paragraphs 22-24, further comprising heating the substrate after depositing the metal layer.

Paragraph 26. The method of paragraph 25, wherein heating the substrate comprises heating to a temperature of from 70° C. to 100° C.

Paragraph 27. The method of paragraph 26, wherein the temperature is from 75° C. to 90° C.

Paragraph 28. A method, comprising:
exposing the metal layer of the sensor according to any one of paragraphs 1-21 to an analyte, the metal layer being located on the first surface of the flexible substrate;
exposing the second surface of the flexible substrate of the sensor to light; and
determining the wavelength of the SPR dip.

Paragraph 29. The method of paragraph 28, further comprising contacting the second surface of the substrate with a prism, and wherein exposing the second surface of the flexible substrate of the sensor to light comprises exposing the prism to the light.

Paragraph 30. The method of paragraph 28 or paragraph 29, wherein the light comprises visible and infrared light.

Paragraph 31. The method of any one of paragraphs 28-30, wherein the light has a wavelength of from 200 nm to 2200 nm.

Paragraph 32. The method of paragraph 31, wherein the light has a wavelength of from 300 nm to 1800 nm.

### VI. EXAMPLES

### Example 1

### Process to Make the Flexible Ag-Coated or Au-Coated SPR Chip

A large area of Kapton® sheet (10 cm×5 cm) was cut from the bulk Kapton® sheet. Before metal coating onto the flexible substrate, the substrate (Kapton®) was cleaned with DI water, followed by acetone, isopropanol (IPA), and dried with nitrogen. After cleaning, plasma treatment was applied to the substrate to increase the adhesion between the metal and the substrate and remove any unwanted organic particles.

After the plasma treatment, the plasmonic material was applied by physical vapor deposition (PVD) or RF sputtering deposition techniques. The thickness of the Au or Ag on the Kapton® was 50 nm and 47 nm, respectively. As the Kapton® substrate surface was not as smooth as a glass substrate, the coated chip was annealed after deposition. During annealing, the metal-coated substrate was placed in an oven at 80° C. for 15 minutes. The annealing process provided a roughness-free surface of the flexible SPR chip. The schematic of the complete fabrication process flow chart is shown in FIG. 5. This method supports large-area fabrication of the SPR chip. As the fabricated chip is on a polyimide substrate, it can be cut into different sizes after fabrication.

### Example 2

### Graphene Transfer Process

A large area of graphene sheet (2.5 cm×2.5 cm) on PMMA was purchased from the ACS material. To transfer the graphene sheet from the PMMA to the disclosed SPR chip, the PMMA-coated sheet of graphene was first dipped into the DI water for 2 hours to ensure it was fully soaked before transferring to the SPR chip. The PMMA side remained on top in the DI water to facilitate a successful transfer process.

After the transfer, the SPR chip was held vertically for about 20 minutes to let excess water flow out from the chip. After allowing it to dry naturally for 30 minutes, the chip was baked at 40° C. for 30 minutes to remove any residual water.

After completely removing the water, the SPR chip and graphene were immersed in acetone overnight to remove the PMMA. The chip was then baked in an oven at 40° C. with a blower running on low speed for 10 minutes to remove any residual acetone.

### Example 3

### Effect of Graphene on SPR Sensing

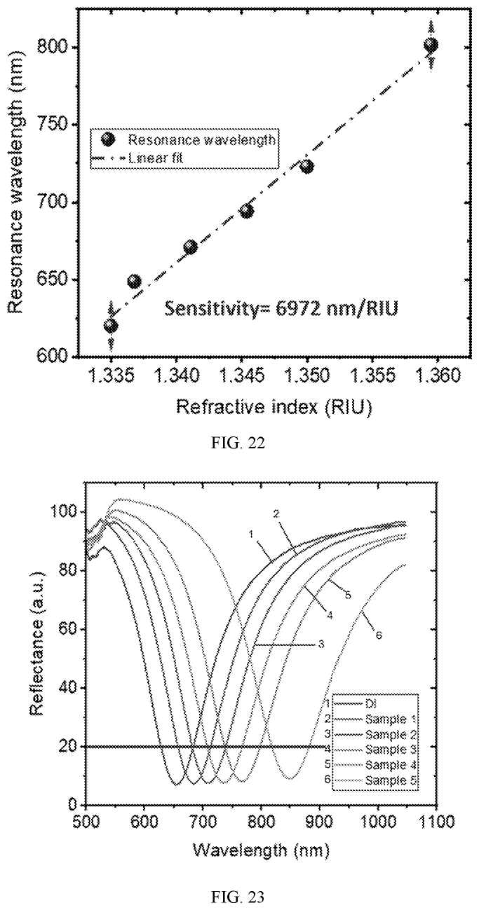

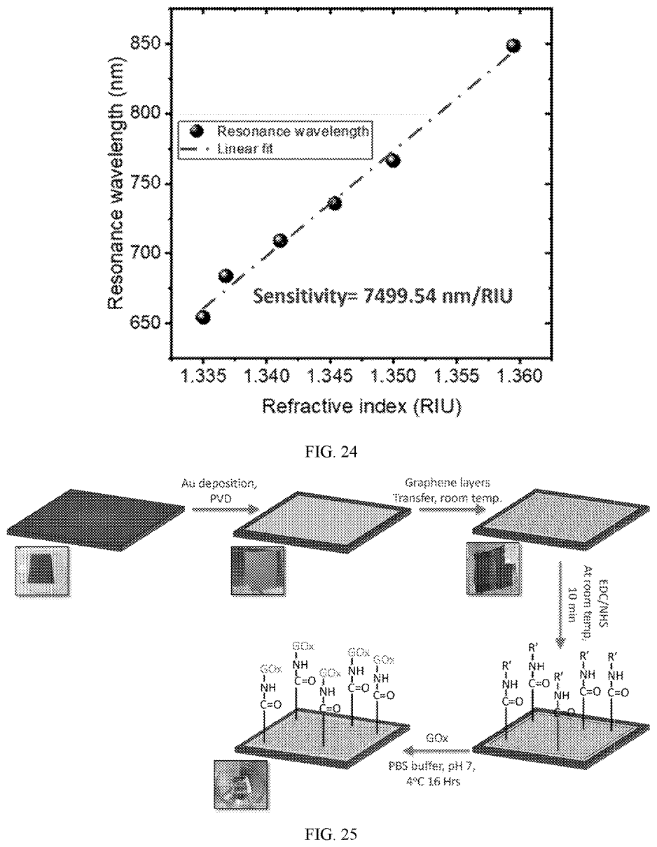

To assess the graphene effect on the performance of the SPR chip, sensing studies using the SPR chip before and graphene transfer were performed. Six samples were prepared with different refractive indices in the DI water and the sensing performance was measured. The refractive indices of samples were calculated with the refractometer (HI96800 Digital Refractometer). FIGS. 21-24 provide data illustrating the performance of the sensor with different refractive indices before (FIGS. 21 and 22) and after (FIGS. 23 and 24) the single-layer graphene transfer to the SPR chip. The experimental results, as shown in FIGS. 22 and 24 clearly demonstrate that the sensor sensitivity increased from 6972 nm/RIU to 7499.54 nm/RIU and increased the light interaction with surface plasmon polariton (SPP) at the surface of the sensor.

### Example 4

### Surface Functionalization

A gold-coated Kapton® sheet was used to make a biosensor to detect the glucose levels. A single layer of graphene was transferred to the gold-coated flexible SPR chip. The graphene layer on the sensor surface increased the sensor's performance and the binding sites for the glucose oxidase (GOx) enzyme. The graphene transfer method is described herein. The following method was used to functionalize the graphene surface and is shown in FIG. 25. With respect to FIG. 25, a graphene-coated flexible SPR chip surface was rinsed with 1×PBS (that is, isotonic PBS) before enzyme functionalization. A well-established EDC/NHS chemistry was used to activate the graphene surface for the GOx. For this purpose, an EDC (5 mL, 200 mM) and NHS ester (5 mL, 50 mM) solution was prepared in 1×PBS and applied to the graphene-coated surface for 10 minutes to modify and activate the surface of the chip with the carboxyl group. The combination of EDC and NHS converted the carboxyl group into amino-active NHS esters that improve the efficiency of attaching GOx to the probe. Then, the GOx enzyme solution (5 mL, 2 mM) was applied to the SPR chip and placed at 4° C. for 12 hours. The amino functional group of the GOx enzyme reacts with the activated carboxyl group to attach the enzyme to the surface.

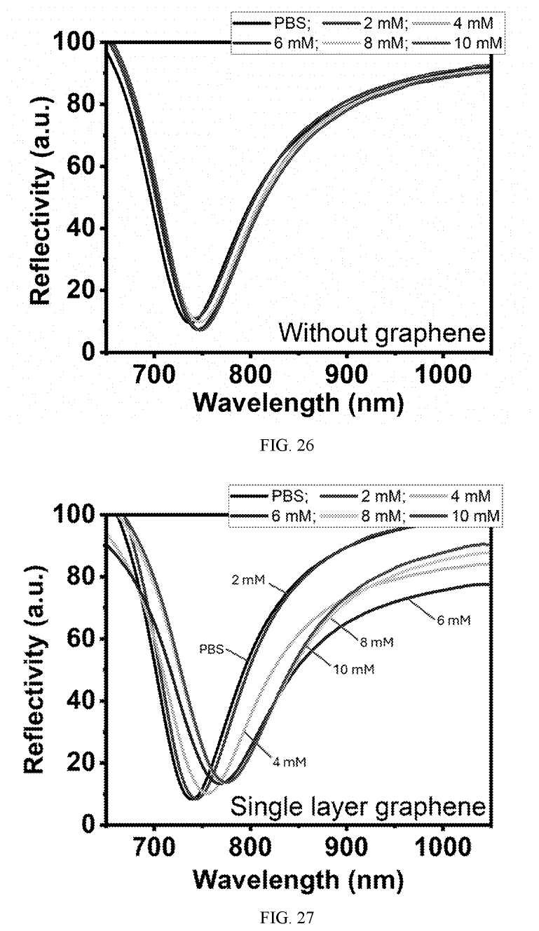

To check the sensitivity of the SPR chip after functionalization with GOx, glucose solutions with concentrations of 0 mM, 2 mM, 4 mM, 6 mM, 8 mM, and 10 mM were prepared in 1×PBS and applied to the sensor surface. FIGS. 26 and 27 demonstrate the sensing performance of the disclosed sensing chip without (FIG. 26) and with (FIG. 27) GOx functionalization of the surface. FIGS. 26 and 27 clearly demonstrate that the sensor with the graphene and GOx layer had a higher sensitivity than the sensor that did not have the graphene/Gox layer.

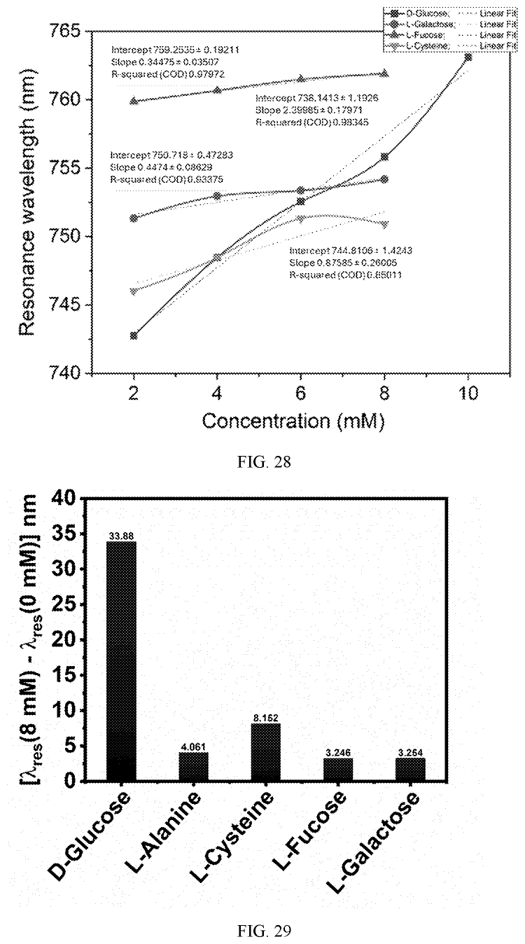

To evaluate the cross-sensitivity of the GOx functionalized SPR sensor, substances that may be expected to provide signals that interfere with measuring the glucose concentration were inspected. The spectral responses of L-Alanine, L-Cysteine, L-Fucose, and L-Galactose, each at a concentration of 8 mM, were compared to the response from D-glucose. FIGS. 28 and 29 provides the respective resonance wavelength shift of the GOx sensor. No distinct shifts were observed after the sensor was dropped with other interferent solutions, indicating that the disclosed glucose sensors have good selectivity.

In view of the many possible aspects to which the principles of the disclosure may be applied, it should be recognized that the illustrated aspects are only preferred examples of the disclosure and should not be taken as limiting the scope of the disclosure. Rather, the scope of the disclosure is defined by the following claims. We therefore claim as the disclosure all that comes within the scope and spirit of these claims.

We claim:

1. A flexible surface plasmon resonance sensor, comprising:
a flexible substrate having a first surface and a second surface; and
a plasmonic metal layer in direct physical contact with the first surface of the flexible substrate, the plasmonic metal layer having a metal layer thickness of from greater than zero to 60 nm;
wherein the flexible surface plasmon resonance sensor does not comprise an adhesion layer between the substrate and the plasmonic metal layer.

2. The sensor of claim 1, wherein the flexible substrate is a polyimide.

3. The sensor of claim 1, wherein the flexible substrate has a substrate thickness of from 20 μm to 500 μm.

4. The sensor of claim 1, wherein the substrate has a refractive index of from 1.5 to 1.8 at 633 nm.

5. The sensor of claim 1, wherein the metal is gold, silver, copper, or a combination thereof.

6. The sensor of claim 1, wherein the metal is gold.

7. The sensor of claim 1, wherein the sensor and the substrate are both sufficiently flexible to be able to form a bend having a diameter of up to 1 mm without forming a crease or cracking either the substrate or the metal film.

8. The sensor of claim 1, wherein the metal layer thickness is from 15 nm to 50 nm.

9. The sensor of claim 1, wherein the metal layer has a first surface and a second surface and the first surface of the metal layer is in direct physical contact with the first surface of the substrate and the second surface of the metal layer is functionalized to be selective for one or more analytes.

10. The sensor of claim 1, wherein the sensor further comprises a prism in contact with or adjacent to the second surface of the substrate.

11. The sensor of claim 10, wherein the prism is in direct physical contact with the second surface of the substrate.

12. The sensor of claim 10, wherein the prism is separated from the second surface of the substrate by a fluid layer.

13. The sensor of claim 12, wherein the fluid layer has a thickness of from greater than zero to 2 nm.

14. The sensor of claim 12, wherein the fluid has a refractive index within about 1% of the refractive index of the flexible substrate.

15. A method for making the sensor of claim 1, the method comprising:
providing a flexible substrate having a first surface;
cleaning the first surface of the substrate; and
depositing a flexible metal layer on the first surface of the substrate.

16. The method of claim 15, further comprising cutting the flexible substrate to form a sensor of a smaller, desired size.

17. The method of claim 15, wherein depositing the flexible metal layer is performed by thermal chemical vapor deposition (CVD), physical vapor deposition (PVD), RF sputtering, atomic layer deposition (ALD), plasma-enhanced chemical vapor deposition (PE-CVD), or plasma-activated chemical vapor deposition (PACVD).

18. The method of claim 15, further comprising heating the substrate to a temperature of from 70° C. to 100° C. after depositing the metal layer.

19. A method, comprising:
exposing the metal layer of the sensor according to claim 1 to an analyte, the metal layer being located on the first surface of the flexible substrate;
exposing the second surface of the flexible substrate of the sensor to light having a wavelength of from 200 nm to 2200 nm; and
determining the wavelength of the SPR dip.

20. The method of claim 19, further comprising contacting the second surface of the substrate with a prism, and wherein exposing the second surface of the flexible substrate of the sensor to light comprises exposing the prism to the light.
